(19) United States
(12) Patent Application Publication
(10) Pub. No.: US 2023/0294765 A1
(43) Pub. Date: Sep. 21, 2023

(54) SOCKET JOINT AND METHOD OF MANUFACTURING

(71) Applicant: FEDERAL-MOGUL MOTORPARTS LLC, Southfield, MI (US)

(72) Inventors: Roger G. Sellers, Arnold, MO (US); Dustin Schrieber, Waterloo, IL (US); Trevor G. Seibert, Millstad, IL (US)

(21) Appl. No.: 17/695,758

(22) Filed: Mar. 15, 2022

(51) Int. Cl. B62D 7/18; B60G 3/06

(52) U.S. Cl. CPC B62D 7/18; B60G 3/06; B60G 2204/416; B60G 2200/17; B60G 2200/142

(57) ABSTRACT

A socket joint having an offset housing configuration and reduced stud diameter can improve steering performance while being able to mate with standard vehicle components. In one implementation, the joint has an offset configuration along with a spherical bearing, where a central housing axis is radially offset from a central stud axis. With the offset configuration, the size of the stud is smaller than with typical joints. In one embodiment, a ratio of the housed stud diameter to the housing outer diameter is between 1:1.5 and 1:2.72. In some implementations, there is a transition surface between the housed stud portion and an attachment stud portion on the stud. One or more helical oil grooves may be located between the transition surface and a retaining ring groove. The retaining ring groove can be used to situate a retaining ring that holds the stud assembly together.

### TECHNICAL FIELD

This invention generally relates to vehicle components and, in particular, to socket joints used in steering and suspension systems.

### BACKGROUND

With some solid axle vehicle implementations, proper adjustment of camber and/or caster can be a challenge. To provide this adjustment, a socket joint in which the central axis of the housing is offset from the central axis of the stud can be used. However, allowing the stud to maintain a pivot aides with corresponding vehicle component alignment. Also, the stud should be allowed to move axially to further align with the mating components. The socket joint described herein can be used to accomplish these goals.

### SUMMARY

According to one embodiment, there is provided a socket joint comprising a stud having a housed stud portion and an attachment stud portion. The stud has a central stud axis extending through the housed stud portion and the attachment stud portion. A spherical bearing at least partially surrounds the stud, and a housing at least partially surrounding the bearing. The housing has a central housing axis. The central stud axis and the central housing axis are radially spaced from each other.

In some embodiments, the housed stud portion has a housed stud diameter and the housing has a housing outer diameter, and a ratio of the housed stud diameter to the housing outer diameter is between 1:1.5 and 1:2.72, inclusive.

In some embodiments, the ratio of the housed stud diameter to the housing outer diameter is between 1:2 and 1:2.5, inclusive.

In some embodiments, the housed stud portion has a retaining ring groove and a retaining ring situated at least partially within the retaining ring groove.

In some embodiments, there is an oil channel groove on the housed stud portion.

In some embodiments, the oil channel groove extends helically around the housed stud portion.

In some embodiments, the stud has a transition surface between the housed stud portion and the attachment stud portion, wherein the housed stud portion has a housed stud diameter and the attachment stud portion has an attachment stud diameter, with the housed stud diameter being smaller than the attachment stud diameter.

In some embodiments, the transition surface between the housed stud portion and the attachment stud portion is angled parallel with respect to a base surface of the housing or angled at least partially away from the base surface of the housing.

In accordance with another embodiment, there is provided a socket joint comprising a stud having a housed stud portion with a housed stud diameter. A housing at least partially surrounds the housed stud portion of the stud, the housing having a housing outer diameter. A ratio of the housed stud diameter to the housing outer diameter is between 1:1.5 and 1:2.72, inclusive.

In some embodiments, the ratio of the housed stud diameter to the housing outer diameter is between 1:2 and 1:2.5, inclusive.

In some embodiments, the stud has a central stud axis extending through the housed stud portion and an attachment stud portion, the housing has a central housing axis, and the central stud axis and the central housing axis are radially spaced from each other.

In accordance with another embodiment, there is provided a socket joint comprising a stud having a housed stud portion, an attachment stud portion, and a transition surface between the housed stud portion and the attachment stud portion. The housed stud portion has a housed stud diameter and the attachment stud portion has an attachment stud diameter, with the housed stud diameter being smaller than the attachment stud diameter. The joint includes a housing at least partially surrounding the stud at the housed stud portion, the housing extending between a top surface and a base surface. The transition surface between the housed stud portion and the attachment stud portion is angled parallel with respect to the base surface of the housing or is angled at least partially away from the base surface of the housing.

In some embodiments, an oil channel groove is situated on the housed stud portion and extends between a retaining ring groove and the transition surface.

In some embodiments, the oil channel groove is helically arranged around the housed stud portion.

In accordance with another embodiment, there is provided a socket joint comprising a stud having a housed stud portion and an attachment stud portion. The housed stud portion has a retaining ring groove. A bearing at least partially surrounds the stud, the bearing having an inner bearing diameter and an outer bearing diameter. A housing at least partially surrounds the bearing, and a retaining ring is situated at least partially within the retaining ring groove. The retaining ring has an inner retaining ring diameter and an outer retaining ring diameter, and the outer retaining ring diameter is larger than the inner bearing diameter.

In some embodiments, a difference between the outer retaining ring diameter and the inner retaining ring diameter is less than a depth of the retaining ring groove.

In some embodiments, an oil channel groove is situated on the housed stud portion and extends between the retaining ring groove and a transition surface.

In some embodiments, the oil channel groove is helically arranged around the housed stud portion.

In accordance with one embodiment, there is a method of manufacturing a socket joint comprising the steps of: arranging the bearing around the stud; inserting the retaining ring into the retaining ring groove; and inserting the bearing, the stud, and the retaining ring into a bore in the housing. Some embodiments may include the step of induction heat treating the stud.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### BRIEF DESCRIPTION OF THE DRAWINGS

Preferred example embodiments will hereinafter be described in conjunction with the appended drawings, wherein like designations denote like elements, and wherein:

FIG. 1 is a partial side view of a suspension assembly having a socket joint according to one embodiment;

FIG. 2 is a cross-section view of the socket joint of FIG. 1;

FIG. 3 is a perspective view of the stud of the socket joint of FIGS. 1 and 2; and

FIG. 4 is a side view of a stud for a socket joint, such as the socket joint illustrated in FIGS. 1-3.

### DETAILED DESCRIPTION

The socket joint and manufacturing method described herein provide for improved camber and/or caster adjustment, particularly with solid axle suspension systems. An offset between the central axis of the joint housing and the central axis of the joint stud helps facilitate this improvement, while maintaining sufficient pivoting capabilities for aligning with corresponding vehicle components and maintaining sufficient axial play to further align with the mating components. The stud has a reduced shank diameter, and in at least some implementations, the head or ball is eliminated from the top of the shank to facilitate the use of a spherical bearing in the offset housing. Typically, if the housing bore is offset, a tapered bearing and angled housing could be used. However, these can be more difficult to manufacture. The socket joint and manufacturing method described herein can satisfy more performance requirements without complicating the joint assembly process.

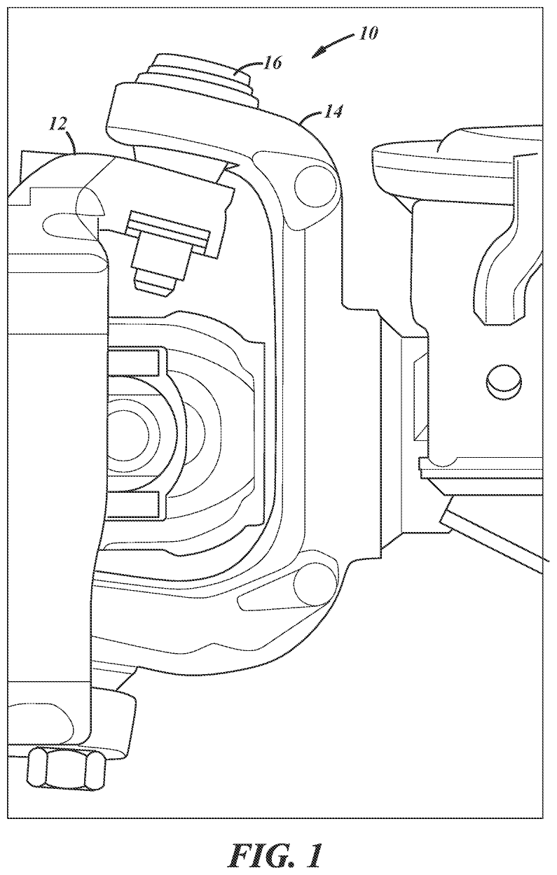

FIG. 1 illustrates one embodiment of a suspension system 10 having a steering knuckle 12 and an upper control arm 14 connected via the socket joint 16. As described above, the socket joint 16 advantageously improves performance when used as an upper ball joint in a system 10 having a solid axle. However, it is possible for the socket joint 16 to be used in other configurations or implementations, particularly those that do not have a solid axle. Further, features relating to the joint 16 may be useful in other joint applications. Accordingly, it is possible to manufacture alternately configured suspension and/or steering components in accordance with the teachings herein. For example, the joint 16 may include any moveable socket configuration, such as those with a ball stud, and is not limited to the explicitly illustrated joint shown in the figures and described herein.

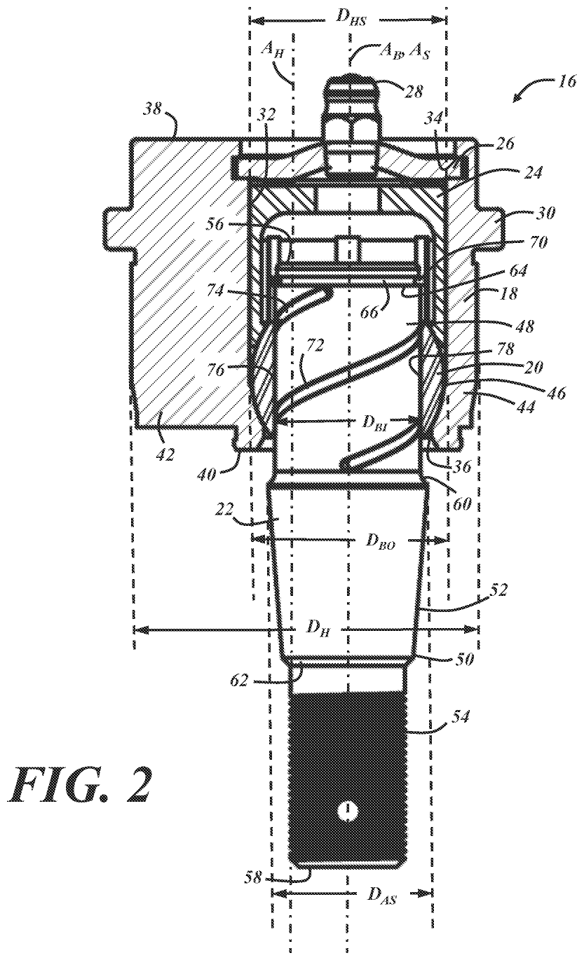

FIG. 2 illustrates one embodiment of the socket joint 16. The socket joint 16 includes a housing 18 at least partially surrounding a bearing 20 and a stud 22. The housing 18, bearing 20, and/or stud 22 can include various threads, grooves, projecting portions, etc., beyond what is particularly illustrated. Other features may also be included, such as the illustrated pressure cup 24, cover plate 26, and grease fitting 28. The socket joint 16 may also include other features, such as a dust boot or other operational-based features depending on the desired use and placement of the joint.

The housing 18 is a generally circular cylindrical component that surrounds the internal components of the joint 16. The housing 18 has a housing outer diameter D_{H}, which is taken at the widest portion of the housing adjacent the stud 22. In the illustrated embodiment, the housing outer diameter D_{H} is the largest diameter portion of the housing 18, with the exception of the radially expanded seating feature 30. In this embodiment, the housing outer diameter D_{H} is about 1.901 inches, but as described in more detail below, this may vary depending on the desired implementation and specifications of the suspension system 10. The housing 18 also has a central housing axis A_{H} that extends through the geometric center of a circle defined by the housing outer diameter D_{H}.

The housing 18 has an internal bore 32 in which the bearing 20 and the stud 22 are situated. Most of the bore 32 is radially consistent, with the exception of a radially expanded portion 34 for seating the cover plate 26 and a radially contracted portion 36 for seating the bearing 20. The radially expanded portion 34 of the bore 32 is located closer toward a top surface 38 of the housing 18, and the radially contracted portion 36 of the bore is located closer toward a base surface 40 of the housing. The bore 32 is offset such that the housing 18 includes a first thicker side 42 and a second thinner side 44. Accordingly, a central axis of the bore A_{B}, which extends axially through the center of the bore 32, is radially offset from the central housing axis A_{H}. This arrangement can help provide improved camber and/or caster adjustment. However, in order to manufacture an offset within the confines of the housing outer diameter D_{H}, which is generally dictated by the needs of the suspension system 10, the internal bore 32 needs to be downsized, and accordingly, the internal components within the bore need to be proportionally downsized as well. As detailed herein, this downsizing, while maintaining requisite performance attributes, can be challenging.

The bearing 20 is situated in the internal bore 32 of the housing 18. The bearing 20 is advantageously a spherical bearing having a spherical outer profile 46. The spherical bearing 20 is smaller than with typical joints, in order to help facilitate the offset configuration. In the illustrated example, the outer diameter of the bearing D_{BO} is about 1.060 inches, which is smaller than more standard joint bearings (e.g., having a bearing diameter of about 1.250 inches or more). Additionally, the difference between the outer diameter of the bearing D_{BO} and the inner diameter of the bearing D_{BI} is smaller than more standard joint bearings. In one example, the spherical bearing 20 is a gas carburized steel bearing to help decrease friction and increase durability, but other materials are certainly possible, such as a carbon fiber reinforced plastic, to cite one potential example. Moreover, the spherical outer profile 46 of the bearing 20 can help promote more uniform wearing, as opposed to tapered bearings or the like. However, to allow for the spherical outer profile 46, the size of the stud 22 must also be reduced.

Example embodiments of the stud 22 are shown in FIGS. 2-4. The stud 22 has a housed stud portion 48 and an attachment stud portion 50. The attachment stud portion 50 may be further subdivided into an intermediate tapered section 52 and a threaded section 54. The housed stud portion 48 is located adjacent a top surface 56 of the stud 22, and the attachment stud portion 50 is located adjacent a base surface 58 of the stud. The housed stud portion 48 is generally situated within the internal bore 32 of the housing 18, and the attachment stud portion 50 extends down from a transition surface 60 located just below the base surface 40 of the housing. A second transition surface 62 separates the intermediate section 52 and the threaded section 54 of the attachment stud portion 50.

The stud 22 has a central stud axis A_{S} that extends through the radial center point of the housed stud portion 48 and the attachment stud portion 50. Given that the stud 22 is centrally arranged within the internal bore 32 of the housing 18, the stud and the bore are coaxial, as shown in FIG. 2 with a coaligned central stud axis A_{S} and central bore axis A_{B}. Accordingly, the central stud axis A_{S}, like the central bore axis A_{B}, is radially offset with respect to the central housing axis A_{H}. This arrangement can help improve performance, such as improved camber and/or caster adjustability.

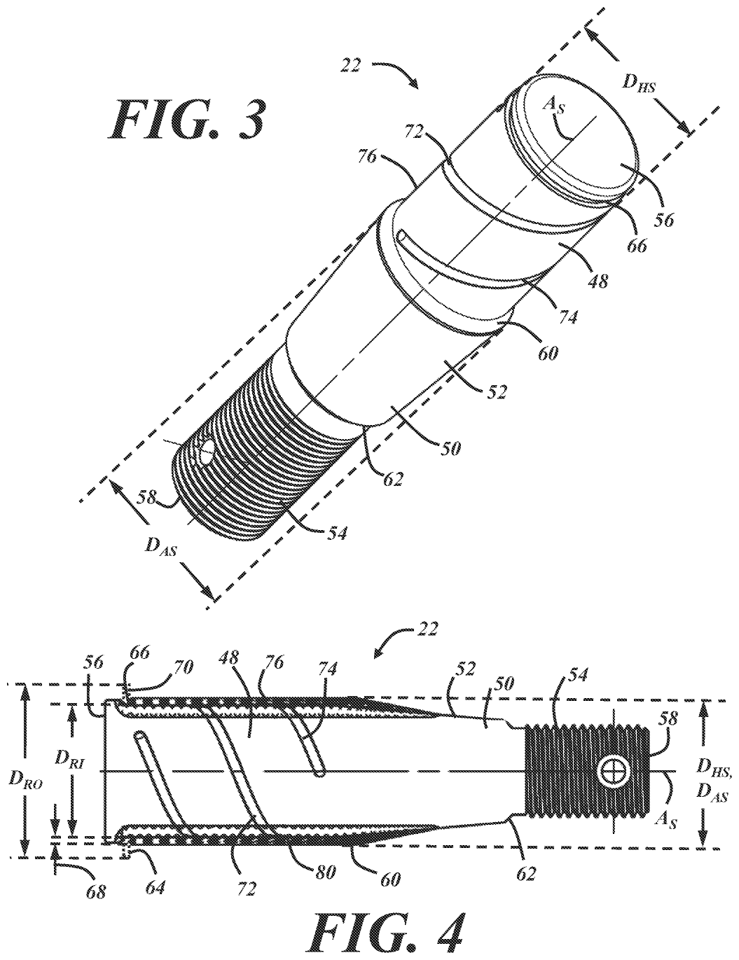

As opposed to a stud that has an integral projecting lip or ball-type end, the stud 22 does not have a projecting lip, which allows for the stud to be inserted into the spherical bearing 20. The bearing 20 can then be retained in place with a retaining ring 64 that is situated in a retaining ring groove 66 that extends around the entire circumference of the housed stud portion 48. FIG. 2 shows the retained stud 22 and retaining ring 64, and FIG. 3 shows the stud without the retaining ring so that the retaining ring groove 66 is more visible. In FIG. 4, the retaining ring 64 is represented in dotted lines to illustrate the inner retaining ring diameter D_{RI} and the outer retaining ring diameter D_{RO}. A difference between the outer retaining ring diameter D_{RO} and the inner retaining ring diameter D_{RI} is less than a depth 68 of the retaining ring groove 66. This provides a projecting portion 70 of the retaining ring 64 that helps retain the stud 22 with respect to the bearing 20 and can limit axial play of the stud 22 within the bore 32. Further, the outer retaining ring diameter D_{RO} is larger than the inner bearing diameter D_{BI} in order to help retain the stud 22 with respect to the bearing 20. This can help streamline manufacturing efforts, since the bearing 20 can be assembled by slipping it over the top surface 56 of the stud before adding the retaining ring 64, which may not be feasible with studs having a projecting lip or the like.

The stud 22 also includes a plurality of helical oil channel grooves 72, 74 located on an outer surface 76 of the housed stud portion 48. Given the size reduction of the stud 22 to accommodate the offset housing arrangement, there is a corresponding reduction in available bearing surfaces. Testing of the small shank stud 22 showed excessive wear between the outer surface 76 of the housed stud portion 48 and the inner surface 78 of the bearing 20. The smaller bearing surface between these two components resulted in higher contact bearing pressure for the same amount of load. Review of the tested parts showed that excessive wear is likely the result of insufficient lubrication on the bearing surface in this region. While in some embodiments, the helical oil channel grooves 72, 74 may be used to remedy the problem of insufficient lubrication, alternately configured grooves or no oil channel grooves at all may be feasible options as well. However, the helical oil channel grooves 72, 74 helped ensure that the grease was being adequately distributed around and between the stud 22 and bearing 20 interface. Advantageously, the helical shape of the grooves 72, 74 resulted in improved lubrication compared with more standard, straight grease grooves. In some embodiments, the grooves 72, 74 may be located on the inner surface of the bearing 78, whether in addition to or as an alternative to locating them on the outer surface 76 of the housed stud portion 48. It may be more cost effective, however, to locate the helical oil channel grooves 72, 74 on the stud 22 as opposed to on the bearing 20.

The illustrated embodiments include two oil channel grooves 72, 74 that extend helically around the housed stud portion 48 between the retaining ring groove 66 and the transition surface 60. The two oil channel grooves 72, 74 generally stop and start at similar axial positions along the length of the stud 22, corresponding to the retaining ring groove 66 and the transition surface 60 respectively, which can help improve lubrication distribution across the outer surface 76 of the housed stud portion 48. The grooves 72, 74 preferably each extend more than 360° around the outer surface 76 of the housed stud portion 48, and in the illustrated embodiment, they extend over 390°. Other arrangements for the grooves 72, 74 are certainly possible, and the inclusion of more or less grooves than what is specifically illustrated is possible as well.

As detailed herein, the size of the stud 22, particularly at the housed stud portion 48, is reduced to facilitate the offset arrangement of the stud 22 with respect to the housing 18. The diameter of the housing D_{H} and the diameter of the attachment stud portion D_{AS} are generally dictated by the configuration of the suspension system 10. Accordingly, to facilitate the offset, the stud 22 must be diametrically reduced, particularly the diameter of the housed stud portion D_{HS}. The diameter of the attachment stud portion D_{AS} is taken at its largest extent between the transition 60 and the base surface 58 of the stud 22. The diameter of the housed stud portion D_{HS} is taken at its largest extent at the outer surface 76 that is surrounded by the housing 18.

The ratio of the diameter of the housed stud portion D_{HS} to the housing outer diameter D_{H} can be particularly controlled to accommodate the offset configuration and use of a spherical bearing 20, while maintaining a sufficient amount of available bearing surface area. In an advantageous embodiment, the ratio of the housed stud diameter D_{HS} to the housing outer diameter D_{H} is between 1:1.5 and 1:2.72, inclusive. This range is distinguishable from typical joints, which usually have a ratio that is closer to 1:1, and do not have an offset. In an even more advantageous embodiment, the ratio of the housed stud diameter D_{HS} to the housing outer diameter D_{H} is 1:2 to 1:2.5 inclusive. In one particular example, the housed stud diameter D_{HS} is about 0.8 inches and the housing outer diameter D_{H} is about 1.9 inches. The size of the housing D_{H} may vary between 1 to 5 inches, for example, with a corresponding proportional change to the housed stud diameter D_{HS}. Given a housing outer diameter D_{H} of 1.9 inches, which as explained, is often dictated by the configuration of the suspension system 10, the housed stud diameter D_{HS} can be reduced to about 0.7 inches while maintaining a sufficient amount of bearing area. The size reduction should be balanced with the need to maintain fatigue strength and fatigue life, and a ratio of D_{HS} to D_{H} between 1:1.5 and 1:2.72, and more particularly, 1:2 to 1:2.5, can help accomplish this.

Given the diametric variation between the housed stud portion 48 and the attachment stud portion 50, a transition surface 60 can be used to facilitate the smaller stud size at the housed stud portion while maintaining the ability of the attachment stud portion to properly mount with the mating surface in the suspension system 10. As shown in FIG. 2, the transition surface 60 is angled at least partially away from the base surface 40 of the housing, and in some embodiments, may be angled parallel with respect to the base surface (i.e., a straight step out). This angular configuration of the transition surface 60 provides for a larger attachment stud diameter D_{AS}, as compared with arrangements such as that shown in the embodiment of FIG. 4, where the transition 60 is merely an angle to taper the intermediate section 52 toward the threaded section 54. Further, by orienting the transition surface 60 such that it is parallel to or angled away from the base surface 40 of the housing, it can be easier to manufacture than transition surfaces that are angled toward the housing.

During assembly of the joint 16, the bearing 20 is placed around the stud 22 at the housed stud portion 48. Given the essentially radially consistent configuration of the housed stud portion 48 (i.e., without a ball or radially projecting rib or lip at the top surface 56), a smaller spherical bearing 20 can be used, and then the retaining ring 64 can hold the stud assembly together. The retaining ring 64 may be a snap ring or the like that seats in the retaining ring groove 66 for proper positioning and retention. The stud assembly with the stud 22, bearing 20, and retaining ring 64 can then be inserted into the bore 32 of the housing 18.

In some manufacturing embodiments, an induction heat treatment process is used on the stud 22 before the assembly process. The heat treatment process in accordance with one implementation involves quenching and tempering the entire stud 22 to RC 28-35. Following the initial quench and temper process, the stud 22 can be induction hardened in accordance with the pattern 80 illustrated in FIG. 4, with an approximately 350° F. draw for about an hour. Reference numeral 80 also represents the reduced diameter section of the stud 22. This induction heat treatment process can increase fatigue strength on the wear surface 76, which is particularly beneficial given the reduced size of the stud 22.

It is to be understood that the foregoing is a description of one or more preferred example embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A socket joint, comprising:
a stud having a housed stud portion and an attachment stud portion, the stud having a central stud axis extending through the housed stud portion and the attachment stud portion;
a spherical bearing at least partially surrounding the stud; and
a housing at least partially surrounding the bearing, the housing having a central housing axis, wherein the central stud axis and the central housing axis are radially spaced from each other.

2. The socket joint of claim 1, wherein the housed stud portion has a housed stud diameter and the housing has a housing outer diameter, and a ratio of the housed stud diameter to the housing outer diameter is between 1:1.5 and 1:2.72, inclusive.

3. The socket joint of claim 2, wherein the ratio of the housed stud diameter to the housing outer diameter is between 1:2 and 1:2.5, inclusive.

4. The socket joint of claim 1, wherein the housed stud portion has a retaining ring groove and a retaining ring situated at least partially within the retaining ring groove.

5. The socket joint of claim 1, comprising an oil channel groove on the housed stud portion.

6. The socket joint of claim 5, wherein the oil channel groove extends helically around the housed stud portion.

7. The socket joint of claim 1, wherein the stud has a transition surface between the housed stud portion and the attachment stud portion, wherein the housed stud portion has a housed stud diameter and the attachment stud portion has an attachment stud diameter, with the housed stud diameter being smaller than the attachment stud diameter.

8. The socket joint of claim 7, wherein the transition surface between the housed stud portion and the attachment stud portion is angled parallel with respect to a base surface of the housing or angled at least partially away from the base surface of the housing.

9. A socket joint, comprising:
a stud having a housed stud portion with a housed stud diameter; and
a housing at least partially surrounding the housed stud portion of the stud, the housing having a housing outer diameter, wherein a ratio of the housed stud diameter to the housing outer diameter is between 1:1.5 and 1:2.72, inclusive.

10. The socket joint of claim 9, wherein the ratio of the housed stud diameter to the housing outer diameter is between 1:2 and 1:2.5, inclusive.

11. The socket joint of claim 9, wherein the stud has a central stud axis extending through the housed stud portion and an attachment stud portion, the housing has a central housing axis, and the central stud axis and the central housing axis are radially spaced from each other.

12. A socket joint, comprising:
a stud having a housed stud portion, an attachment stud portion, and a transition surface between the housed stud portion and the attachment stud portion, wherein the housed stud portion has a housed stud diameter and the attachment stud portion has an attachment stud diameter, with the housed stud diameter being smaller than the attachment stud diameter; and
a housing at least partially surrounding the stud at the housed stud portion, the housing extending between a top surface and a base surface, wherein the transition surface between the housed stud portion and the attachment stud portion is angled parallel with respect to the base surface of the housing or is angled at least partially away from the base surface of the housing.

13. The socket joint of claim 12, wherein an oil channel groove is situated on the housed stud portion and extends between a retaining ring groove and the transition surface.

14. The socket joint of claim 13, wherein the oil channel groove is helically arranged around the housed stud portion.

15. A socket joint, comprising:
a stud having a housed stud portion and an attachment stud portion, the housed stud portion having a retaining ring groove;
a bearing at least partially surrounding the stud, the bearing having an inner bearing diameter and an outer bearing diameter;
a housing at least partially surrounding the bearing; and
a retaining ring situated at least partially within the retaining ring groove, wherein the retaining ring has an inner retaining ring diameter and an outer retaining ring diameter, wherein the outer retaining ring diameter is larger than the inner bearing diameter.

16. The socket joint of claim 15, wherein a difference between the outer retaining ring diameter and the inner retaining ring diameter is less than a depth of the retaining ring groove.

17. The socket joint of claim 15, wherein an oil channel groove is situated on the housed stud portion and extends between the retaining ring groove and a transition surface.

18. The socket joint of claim 17, wherein the oil channel groove is helically arranged around the housed stud portion.

19. A method of manufacturing the socket joint of claim 15, comprising the steps of:
arranging the bearing around the stud;
inserting the retaining ring into the retaining ring groove; and
inserting the bearing, the stud, and the retaining ring into a bore in the housing.

20. The method of claim 19, further comprising the step of induction heat treating the stud.
